(19) United States
(12) Patent Application Publication
(10) Pub. No.: US 2008/0007388 A1
(43) Pub. Date: Jan. 10, 2008

(54) Apparatus For Identification, Authorisation And/Or Notification

(75) Inventors: Pui Wa Billy Au, Singapore (SG); Boon Keong Teng, Singapore (SG)

Correspondence Address: SUGHRUE MION, PLLC, 2100 PENNSYLVANIA AVENUE, N.W., SUITE 800, WASHINGTON, DC, 20037, US

(73) Assignee: PATCH PTE LTD., Peninsular Plaza (SG)

(21) Appl. No.: 11/547,959

(22) PCT Filed: Apr. 8, 2004
(86) PCT No.: PCT/SG04/00087

§ 371 Date: Oct. 10, 2006

(51) Int. Cl. G06F 7/04

(52) U.S. Cl. 340/5.64

(57) ABSTRACT

Apparatus is disclosed which comprises a sensor-readable contactless tag (2) physically associated with a wireless communication device (4). In one use of the apparatus, the device is arranged to receive a communication in response to reading of the tag. The apparatus is used in performing transactions in which the tag is read by a proximity sensor (20) to capture contact information stored in the tag (2). This is combined by a data processor (40) with transaction information from point of sale terminal (50) this information being sent to a payment processing centre (80) for authorising and confirming a transaction. As part of the authorisation process, the centre (80) seeks telephonic authorisation of the transaction from communication device (4) via telecommunications network (100). Further uses of the embodiment of the invention for providing access and for collection of goods are also disclosed.

### FIELD OF THE INVENTION

This invention relates to apparatus for identification, authorisation and/or notification. More particularly, but not exclusively, this invention relates to such apparatus usable in conjunction with actions such as making a payment, access to premises or collection of previously ordered goods and/or services.

### SUMMARY OF THE INVENTION

According to the invention in a first aspect, there is provided apparatus comprising contactless tag physically associated with a wireless communication device, the tag having contact information of the device and being readable by a proximity sensor.

According to the invention in a second aspect there is provided, transaction apparatus arranged to be used with a sensor-readable contactless tag physically associated with a wireless communication device, the device being arranged to receive a communication in response to reading of the tag and the tag including contact information of the device, the apparatus comprising: a sensor arranged to read the contact information when the tag is brought into proximity with the sensor; a data processor arranged to combine the user information with transaction information; a payment processing means arranged to receive the combined information from the data processor, to establish a caller line identification of the wireless communication device from the combined information and send a notification to the communication device and to authorise the transaction.

According to the invention in a third aspect there is provided apparatus to allow access arranged to be used with a sensor-readable contactless tag physically associated with a communication device, the device being arranged to receive a communication in response to reading of the tag and the tag including contact information of the device, the apparatus comprising: a proximity sensor arranged to read the contact information from the tag when brought into proximity therewith, and a data processing means arranged to receive and verify the contact information and send a signal to an access control means to allow access upon verification.

According to the invention in a fourth aspect there is provided apparatus to identify a purchaser of pre-ordered goods or services arranged to be used with a sensor-readable contactless tag physically associated with a communication device, the tag having contact information of the device, the apparatus comprising: a proximity sensor arranged to read the contact information from the tag when brought into proximity therewith, and a data processing means arranged to receive the contact information at the time of order and compare the previously received contact information with the contact information read by the proximity sensor to identify the purchaser.

According to the invention in a fifth aspect there is provided a battery arranged to be used with a communication device, the battery having a tag with contact information of the device, the tag being readable by a proximity sensor.

According to the invention in a sixth aspect there is provided an accessory normally physically associated with a communication device, the accessory having a tag with contact information of the device, the tag being readable by a proximity sensor.

In the described embodiment of the invention, a contactless tag in the form of an RFID chip is secured to a mobile telephone. The tag includes contact information of the device such that when the mobile telephone is placed in proximity to a contactless sensor, the information may be read. The contact information may then be used to contact the mobile telephone to request authorisation of an action, for example in the case of a transaction or in the case of access to a car park or building. The contact information may alternatively be used simply for identification purposes in the case of collection of previously ordered goods or services. Since the tag is physically associated with the mobile telephone, a unitary device is provided for performing the action.

Since there is a physical association between the tag and the telephone, the user only needs to keep track of a single entity which, in the case of a mobile telephone, is frequently used and the absence of which is likely to be noticed.

### BRIEF DESCRIPTION OF THE DRAWINGS

Embodiments of the invention will now be described, by way of example, with reference to the accompanying drawings in which:

FIGS. 1a and 1b are front and rear views of a contactless tag forming part of the embodiment of the invention;

FIGS. 2a and 2b show rear and front views of a mobile telephone showing the tag affixed to the telephone;

FIG. 3 is a schematic view showing how data from the tag is captured;

FIG. 4 is a schematic view of the embodiment of the invention used in a transaction;

FIG. 5 shows the embodiment of the invention used for car park access;

FIG. 6 shows the embodiment of the invention used for building entry;

FIGS. 7 and 8 show a second embodiment of the invention used in ticket collection and subsequent entry.

### DETAILED DESCRIPTION OF THE PREFERRED EMBODIMENTS

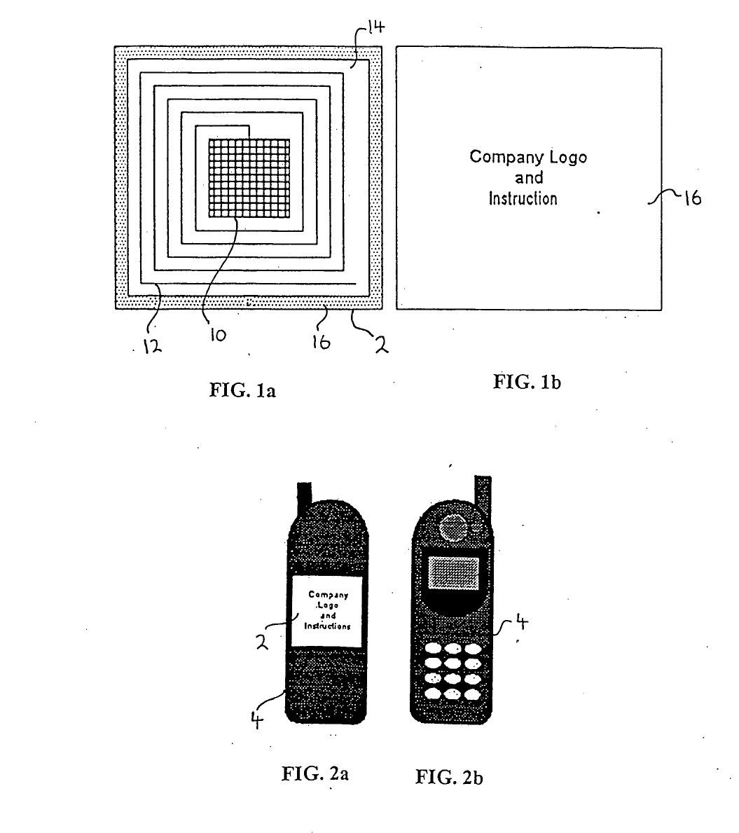

An embodiment of the invention is shown in FIGS. 1 and 2 which comprises the physical association of a contactless tag 2 with a wireless communication device 4. The tag is shown in FIG. 1 and comprises an RFID chip 10 connected to an antenna coil 12 and mounted on a flexible plastic backing sheet 14. The perimeter of the sheet 14 is provided with an adhesive membrane 16 to enable the tag 2 to be affixed to the back of a mobile telephone 4 as shown in FIG. 2a.

As can be seen from FIG. 2, the tag is inobstrusive and does not hinder or affect the user's ability to operate the mobile telephone. Preferably, the reverse side 16 of the tag 2 may include a company logo, advertising or instructional information, together with a hot-line telephone number, in case difficulties are encountered using the tag.

The tag 2 can be of any type based on non-contact short range information exchange and communication technology such as, in the illustrated example, RFID but may also be in the form of a contactless smart card, use Blue Tooth or optical technology such infrared or bar code technology. The physical association of the tag with a communication device may also be by physical integration into or inside the casing of the mobile telephone or may be integrated with the smart-card or battery of the mobile telephone itself. The tag may, alternatively, be affixed to an accessory normally physically associated to the communication device, for example a case. The communication device need not be a mobile telephone but could be a 2-way pager, wireless PDA, palm top or portable data terminal, for example. The tag is arranged to store or indicate contact information of the telephone and may preferably be the caller line identification (CLI) of the mobile telephone 4 although the information may be of any form provided this can be associated with the caller line identification of the device. In one form, the information may be an image of the user or may be other user-related information.

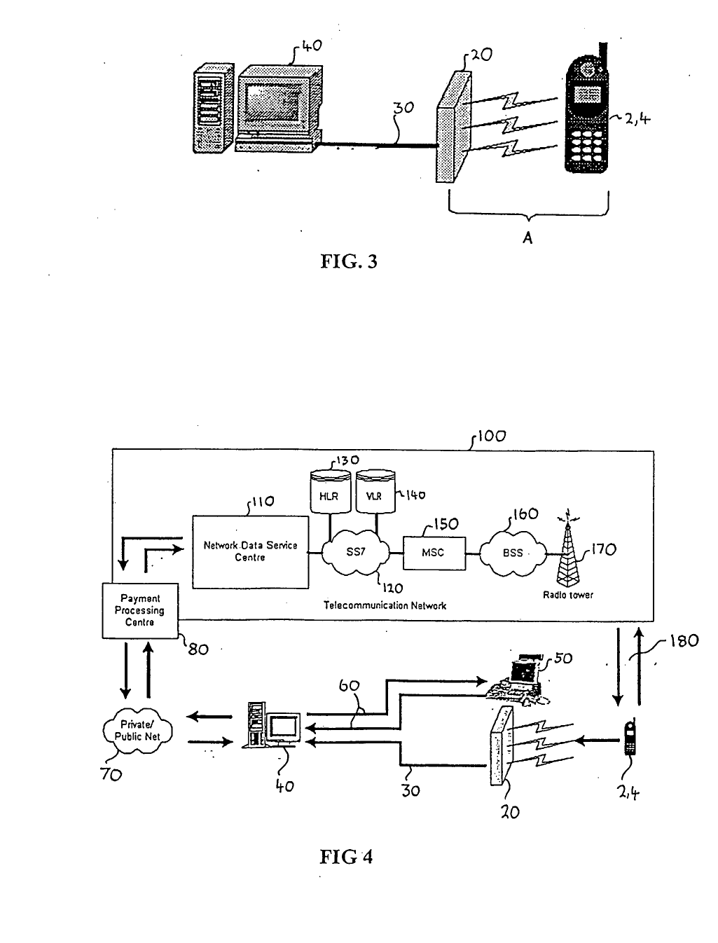

The arrangement of physical association of the tag 2 with the mobile telephone 4 allows the mobile telephone itself to be used as an action confirmation device. FIG. 3 shows a conventional RFID proximity sensor 20 which, when the RFID tag 2 is brought within a range A of the sensor is able to capture the contact information on the tag. This information is transferred via an interface 30 to a data processing unit 40 such as a personal computer and this information is then used to confirm, using the mobile telephone 4, various actions as now described with reference to FIGS. 4 to 8. The described embodiment may be configured for use with one or more than one of the actions described.

FIG. 4 illustrates a transaction using the embodiment of the invention. In FIG. 4 the processing unit 40 is additionally connected to point of sale equipment 50, capable of automatically or manually capturing sales information via a bi-directional link 60 and to a public or private network 70 which may be a conventional telephone land line network. The payment processing centre 80 is further connected to a telecommunication network 100. The centre 80 may be part of network 100 or may be separate.

The processing unit 40 serves to combine the contact information received from the proximity device 20 with sales information such as merchant identity information and the cost of the purchase from the POS device 50 and transmits this combined data via the public/private net 70 to a payment processing centre 80. The data unit 40 may optionally have the capability for various known signal processing techniques such as compression and decompression and/or encryption and decryption, to suit the application.

Thus, the data received by the payment processing centre 80 comprises information indirectly identifying the user/customer and identifying the transaction in the form of merchant identity information and the cost of the purchase. The centre 80 is a central operation unit for processing all data relating to the transaction and performs the functions of (1) obtaining authorisation of the transaction from the user, (2) debiting or instructing the debiting an account of the user and (3) confirming authorisation of the transaction to the merchant at POS terminal 50 via unit 40.

Details of the user's account are kept by the centre in a look-up table associated with the contact information and may, for example, be a mobile telephone account additionally associated with the mobile telephone 4, a bank account, credit card account or any other account suitable for debiting of transactions. The payment processing centre 80 will, upon receipt of the contact information, communicate with the appropriate financial institution for debiting of the account, if necessary or may itself be directly associated with that account so that further communication outside of the payment processing centre to a third party financial institution is unnecessary.

The payment processing centre 80 also is able to initiate a telephonic communication with the mobile telephone 4 upon receipt of the user information. In a preferred form, the contact information is the caller line identification of the telephone but if the contact information comprises a code or image, a look-up table will provide the caller line identification information.

The telecommunication network is of known form comprises a network data service centre 110, Signalling System 7 120, Home Location Register 130, Visitor Location Register 140, Mobile Services Switching Centre 150, Base Station System 160 and Radio Tower 170 to form a cellular telephony network able to communicate over a wireless cellular phone link 180 with mobile telephone 4.

The payment processing centre 80 performs an authorisation request of the transaction by sending a text or voice message to the mobile phone 4 via the telecommunication network 100. This message may simply be in the form of a notification to the mobile telephone in which case only a unidirectional channel 180 is required but preferably the message is in the form of a request for an authorisation which may be aural or may be visual in the form of a SMS (Short Message Service) or USSD (Unstructured Supplementary Service Data) message. The requested authorisation may be in the form of a pre-assigned personalised identification number (pin) entered using the keys of a mobile phone or a pre-arranged phrase to be spoken into the mobile telephone. In the case of the latter, the payment processing centre has biometric voice recognition capability to authenticate the user from the phrase uttered. The authorisation is transmitted by mobile telephone 4 back to centre 80 via network 100.

Upon receipt of the user authorisation from mobile telephone 4 and transactional authorisation (if necessary) from a financial institution with which the tag 2 is associated, the payment processing centre 80 returns a message to POS terminal 50 via unit 40 authorising the transaction.

If any of the checks made by the payment processing centre 80 are not positive or authorisations are not received, the payment processing centre cancels the transaction and advises the merchant accordingly by sending an appropriate message to unit 40, for onward transmission to POS terminal 50.

Where the contact information is an image of the user, the payment processing centre compares the image data with corresponding image data which it holds to establish the caller line identification of the user. As a further safeguard, the image information may subsequently be transmitted with the transaction authorisation message from the payment processing centre 80 to the unit 40 for display on a screen forming part of the unit 40 or POS equipment 50 for verification by a shop assistant of the identity of the user.

When the user authorisation is transmitted from mobile telephone 4 back to payment processing centre 80 via telecommunication network 100, the telecommunication network may also transmit information of the cell in which the mobile telephone 4 is situated. This information can be compared by the payment processing centre 80 with information concerning the merchant determined by the location of the proximity sensor 20 provided in advance to the centre 80 to determine that both the user's mobile telephone 4 and the merchant are the same, as a further check.

The method is not limited to payment for goods but also may be used for payment for services such as for transport by bus, train or taxi, with the sensor, data processing unit and POS terminal being located at a bus stop, station or on the vehicle concerned.

The payment processing centre 80 may have functionality to send additional messages to one or both of the user (via a mobile telephone 4) or the vendor (via POS terminal 50) during or after the transaction. For example, promotional messages could be sent to the mobile telephone based on the cell location of the mobile telephone or personalised account information could be sent to either party. Alternatively, messages could be activity related, being sent based on the user's purchases. The payment processing centre includes a database of products and a database of messages associated with the products. The transaction information identifies the product purchased and, from the databases, a related message is identified which is sent to the user. Thus, for example, if a computer has just been purchased, this may be associated with a message sent to the user's mobile telephone advertising a software bundle for use with the computer. The relationship of the message need not only be to the actual goods purchased but could be related to number or total value of purchases in a location or group of locations, for example in a mall or shopping precinct (identified by the transaction information), or to a total time period spent in that location or group of locations. In the case of the former, the payment processing centre will keep a running total of purchases/payments and send a related message when the purchases/payments exceed a predetermined level. In the case of the latter, a time period between a first purchase and one or more subsequent purchases is monitored by the payment processing centre and if the locations are in the same area and a given time period has been exceeded, a message is sent. Alternatively, location information of the telephone may be provided to the payment processing centre and if the telephone remains in the same area for longer than a predetermined period, a message is sent. This is particularly useful for sending messages related to advertising of services, such as coffee shops, restaurants or massage/reflexology outlets, the services of which may appeal to the user during an extended shopping expedition, for example.

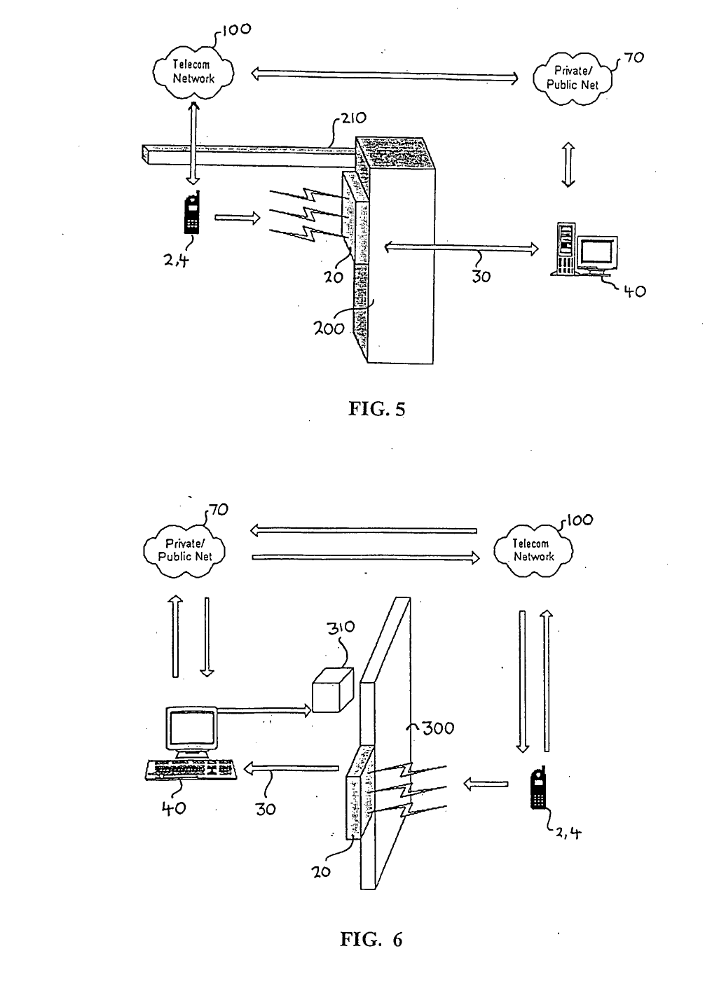

FIG. 5 shows the embodiment of the invention applied to car park entry. Like elements to those shown in FIG. 4 have the same reference numerals and the arrangement is basically similar to that shown in FIG. 4, with the omission of the POS terminal 50 and payment processing centre 80. The unit 40 in this embodiment (and the subsequent embodiment of FIG. 6) is slightly different from the unit 40 of FIG. 4 in that the unit 40 includes a database of contact information for verification purposes and, if necessary, the look up table of caller line identification information, and is able to initiate a telephone call to the mobile telephone 4 directly, rather than these function being performed by payment processing centre 80, which is omitted. Furthermore, the unit 40 includes an interface to open a barrier in the case of this embodiment and to open an electronic lock in the case of FIG. 6 described below. The proximity sensor 20 is attached to a car park barrier support 200 which contains the mechanism for raising and lowering car park barrier 210. Different barriers are provided at the entry and exit points of the car park.

On entry to the car park, the user presents his mobile telephone within range of the proximity sensor 20 to capture the contact information. The contact information is then passed to data processing unit 40 which establishes the contact information and compares this to a database of previously stored contact information. If the contact information is present on the database, this identifies the user as having a right of access and the unit 40 issues a “raise barrier” instruction.

On exit from the car park, the user presents his mobile telephone within range of the proximity sensor 20 to capture the contact information. The contact information is then passed to data processing unit 40 which establishes the caller line identification, compares this to the database and, if the contact information is present, establishes the caller line identification and initiates a telephone message to the user's mobile telephone 4 via public/private net 70 and telecommunications network 100. Upon receipt of the message 4, the user enters an authentication code which is transmitted back to the unit 40 which in turn issues a “raise barrier” instruction to the car park barrier control 200 if the code is correct.

The above described method may be applied for entry/exit from a private car park. For an hourly-based fee-paying car park, a combination of methods of FIGS. 4 and 5 may be used. The apparatus shown in FIG. 5 is used on entry to the car park in the manner described above, the read contact information being associated, by the data processing means, with a time of entry. Upon exit, a similar apparatus to FIG. 5 is used except that the data processing unit 40 also has a connection to a payment processing centre as illustrated in FIG. 4. Upon exit, the contact information is read from the user's mobile telephone and the time that has lapsed since entry is established and a parking fee calculated. This fee is then sent together with the contact information to payment processing centre 80 which then requests an authorisation via telephone network 100 in the embodiment of FIG. 4. Once the authorisation has been received, the car park and fees are debited from the user's account and a signal is sent to data processing unit 40 authorising the transaction, after which the unit 40 opens the barrier.

This method may be combined with general transactions, for example, at a car park of a related supermarket or mall in which merchants accept payment for goods using the scheme of FIG. 4 and the payment processing centre then accumulates the purchases. The same payment processing centre is used for debiting of car park charges so that if the purchases exceed a predetermined limit, this can then set a flag to allow a waiver of car park charges on exit.

The use of the described embodiment for gaining access is shown in FIG. 6 in which proximity sensor 20 is positioned near a barrier 300 the opening of which is controlled by an electronically releasable lock 310. The barrier may for example be a door or gate, allowing controlled access for example to a building, flat, hotel room or outdoor area such as a communal garden. To open the barrier, the mobile telephone 4 is placed within range of the proximity sensor 20 and the contact information is captured to unit 40 via interface 30. This information is compared to the database held by the data processing unit to verify the contact information and upon verification, sends an “open” signal to electronic lock 310 thus allowing the user to enter. The unit 40, optionally, may send a telephonic message to mobile telephone 4 via public/private net 70 and telecommunications network 100 to request a suitable authorisation, in the manner previously described.

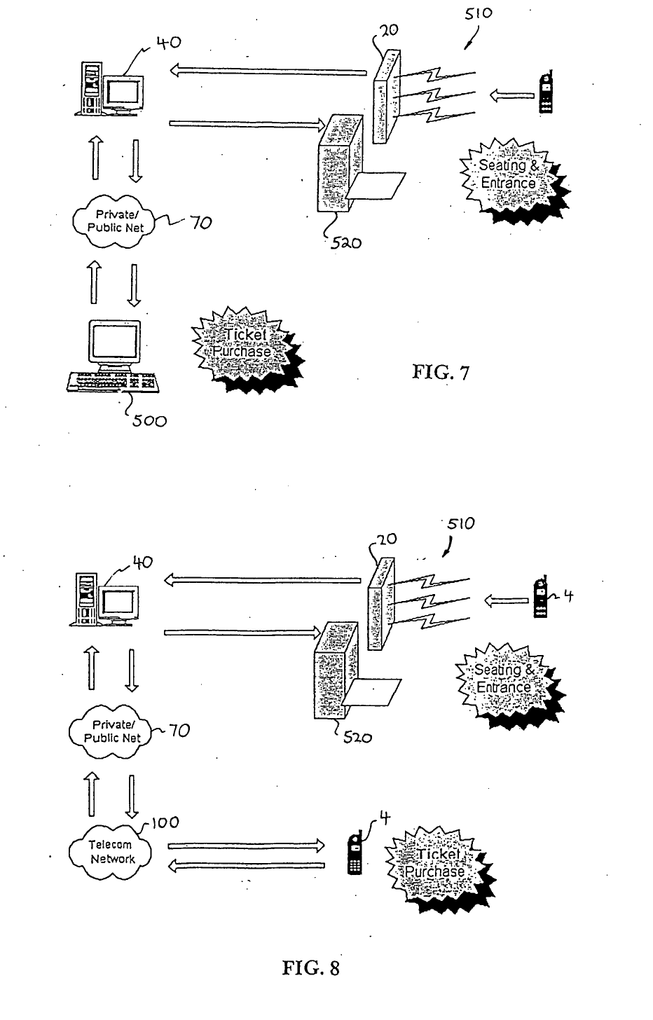

FIGS. 7 and 8 show the use of the embodiment of the invention for subsequent pick-up of goods and/or services previously order. FIGS. 7 and 8 both show alternative methods having specific application in the purchase and subsequent collection of cinema tickets although this method is equally suitable for purchase and subsequent collection of any goods and may also apply to services, for example in booking a tour guide or providing independent confirmation of a restaurant reservation.

In FIG. 7, a first example is shown which cinema tickets are purchased over the internet using a personal computer 500 of the user which communicates with data processing unit 40 via public/private net 70. The mobile telephone and tag 2, 4 are not used in the purchase which can be by any conventional means using, for example, a payment card. During the purchase, the user is required to provide the caller line identification of mobile telephone 4. Subsequently, the user collects the cinema tickets at the cinema location 510 at which it is provided the proximity sensor 20 and a ticket printing machine 520.

Alternatively, the caller line identification may be previously associated with, for example, the payment card number so that the caller line identification information is provided to data processing unit 40 when the transaction is confirmed by the financial institution associated with the payment card.

Upon reading of the tag 2 by proximity sensor 20, data purchasing unit 40 instructs ticket printing machine 520 to print the purchased tickets.

The embodiment of FIG. 8 is similar to FIG. 7 except that the ticket purchase is made using the mobile telephone 4 using existing WAP technology. In this case, the data processing unit will capture the caller line identification of the mobile telephone 4 directly at the time of ticket purchase and will subsequently compare this to the contact information provided on the tag when this is read by sensor 20 at the time of seating and entrance. If the contact information is in the form of a code, access to a suitable centralised look-up table in the manner provided by the central payment processing centre 80 in the embodiment of FIG. 4 is provided.

1-40. (canceled)

41. Apparatus comprising a contactless tag physically associated with the wireless communication device, the tag having a caller line identification of the device and being readable by a proximity sensor, the tag not being in electronic communication with the wireless communication device.

42. Apparatus as claimed in claim 41 wherein the tag is affixed to the wireless communication device.

43. Apparatus as claimed in claim 41 wherein the tag is contained within the wireless communication device.

44. Apparatus as claimed in claim 41 wherein the tag is part of a smart-card of the communication device.

45. Apparatus as claimed in claim 41 wherein the tag is part of or connected to a battery of the communication device.

46. Apparatus as claimed in claim 41 wherein the tag is connected to an accessory normally attached to the communication device.

47. Apparatus as claimed in claim 46 wherein the accessory is a case for the communication device.

48. Apparatus as claimed in claim 41 wherein the communication device is one of a mobile telephone, a wireless pager, a personal digital assistant, palm top or portable data terminal.

49. Apparatus as claimed in claim 41 wherein the tag is usable for making a payment.

50. Apparatus as claimed in claim 41 wherein the tag is usable for gaining access.

51. Apparatus as claimed in claim 41 wherein the tag further includes user information readable by the sensor.

52. Apparatus as claimed in claim 51 wherein the user information comprises an image of the user.

53. Apparatus as claimed in claim 41 further comprising a proximity sensor arranged to read the caller line identification of the tag and data processing means connected to the sensor.

54. Apparatus as claimed in claim 53 wherein the data processing means is arranged to receive the caller line identification from the sensor and to receive transaction information from a point of sale terminal and combine the caller line identification and the transaction information; and a payment processing means arranged to process a transaction based upon the combined information.

55. Apparatus as claimed in claim 54 wherein the payment processing means is arranged to communicate with the wireless communication device over a telecommunication network using the caller line identification to request an authorisation to authorise the transaction.

56. Apparatus as claimed in claim 55 wherein location information of the device is provided by the network to the payment processing centre when the authorisation is obtained.

57. Apparatus as claimed in claim 56 wherein the location information is compared with location information of the point of sale terminal to provide a location verification for the transaction.

58. Apparatus as claimed in claim 56 wherein the payment processing means is arranged to send a location and/or activity related message to the device.

59. Apparatus as claimed in claim 53 wherein the data processing means and sensor are associated with an access restricting means and wherein the data processing means is arranged to allow access on verification of the caller line identification read by the sensor.

60. Apparatus as claimed in claim 59 wherein the data processing means is further arranged to contact the communication device using the caller line identification to seek authorisation from the wireless communication device and allow access on receipt of the authorization.

61. Apparatus as claimed in claim 59 wherein the access restricting means is at an entry or exit to a car park.

62. Apparatus as claimed in claim 59 wherein the access restricting means is arranged to control access to a building, flat, room or outdoor area.

63. Apparatus as claimed in claim 62 wherein the access restricting means is a door or gate.

64. Apparatus as claimed in claim 53 wherein the sensor is associated with a collection point of previously ordered goods or location of previously ordered services and the data processing means is arranged to authorise release of the goods or provision of the services in dependence upon the caller line identification read by the sensor.

65. Apparatus as claimed in claim 64 wherein the goods are tickets.

66. Apparatus as claimed in claim 64 wherein, at the time of order, the caller line identification is provided and the data processing means is arranged to compare the caller line identification provided at the time of order with that read by the sensor.

67. Apparatus as claimed in claim 64 wherein the goods and/or services are previously ordered using the wireless communication device.

68. Transaction apparatus arranged to be used with a sensor-readable contactless tag physically associated with a wireless communication device, the device being arranged to receive a communication in response to reading of the tag and the tag including a caller line identification of the device, the apparatus comprising:
a sensor arranged to read the caller line identification when the tag is brought into proximity with the sensor;
a data processor arranged to combine the caller line identification with transaction information;
a payment processing means arranged to receive the combined information from the data processor, and send a notification to the communication device and to authorise the transaction.

69. Apparatus as claimed in claim 68 wherein the notification is a request for an authorisation from the user of the wireless communication device.

70. Apparatus to allow access arranged to be used with a sensor-readable contactless tag physically associated with a communication device, the device being arranged to receive a communication in response to reading of the tag and the tag including a caller line identification of the device, the apparatus comprising:
a proximity sensor arranged to read the caller line identification from the tag when brought into proximity therewith; and
a data processing means arranged to receive and verify the caller line identification and send a signal to an access control means to allow access upon verification.

71. Apparatus as claimed in claim 70 wherein the data processing means is further arranged to communicate with the wireless communication device seeking authorisation for access and to allow access on receipt of the authorisation.

72. Apparatus as claimed in claim 70 restricting access to one of the car park, building, unit, room or outdoor area.

73. Apparatus to identify a purchaser of pre-ordered goods or services arranged to be used with a sensor-readable contactless tag physically associated with a communication device, the tag having a caller line identification of the device, the apparatus comprising:
a proximity sensor arranged to read the caller line identification from the tag when brought into proximity therewith, and
a data processing means arranged to receive the caller line identification at the time of order and compare the previously received caller line identification with the caller line identification read by the proximity sensor to identify the purchaser.

74. Apparatus as claimed in claim 73 wherein the communication device is arranged to make the purchase and provide the data processing means with the caller line identification at the time of purchase.

75. Apparatus as claimed in claim 73 wherein the data processing means is arranged to receive the caller line identification from the user of the device at the time of purchase.

76. Apparatus as claimed in claim 41 wherein the tag is readable by electromagnetic, magnetic or optical means.

77. A battery arranged to be used with a communication device, the battery having a tag with a caller line identification of the device, the tag being readable by a proximity sensor and not being in electronic communication with the communication device.

78. An accessory normally physically associated with a communication device, the accessory having a tag with a caller line identification of the device, the tag being readable by a proximity sensor and not being in electronic communication with the communication device.
